(19) United States
(12) Patent Application Publication
(10) Pub. No.: US 2021/0197111 A1
(43) Pub. Date: Jul. 1, 2021

(54) AIR PURIFICATION DEVICE WITH FILTER CYLINDER SELF-CLEANING

(71) Applicant: ANHUI CHINTEK INSTRUMENT & EQUIPMENT CO., LTD., Anhui (CN)

(72) Inventors: Jianwu ZHANG, Anhui (CN); Xiaohu ZHANG, Anhui (CN); Yulin YANG, Anhui (CN)

(73) Assignee: ANHUI CHINTEK INSTRUMENT & EQUIPMENT CO., LTD., Anhui (CN)

(21) Appl. No.: 16/309,929

(22) PCT Filed: Oct. 31, 2018
(86) PCT No.: PCT/CN2018/112976

§ 371 Date: Dec. 14, 2018

(30) Foreign Application Priority Data
Sep. 21, 2018 (CN) 201811107268.X

(51) Int. Cl. B01D 46/00; B01D 46/24; B01D 50/00

(52) U.S. Cl. CPC B01D 46/0065; B01D 46/2411; B01D 2279/65; B01D 2257/91; B01D 2273/30; B01D 50/00

(57) ABSTRACT

The present application proposes an air purification device with filter cartridge self-cleaning, which includes: cabinet, air filter cartridge and centrifugal fan, a first mounting plate and a second mounting plate are arranged in the interior of the cabinet from top to bottom, the first mounting plate and the second mounting plate divide the interior of the cabinet into a first chamber, a second chamber, and a third chamber, the cabinet is provided with an air inlet communicating with the first chamber, and with a plurality of air outlets communicating with the third chamber; the air filter cartridge is arranged in the second chamber, the air filter cartridge includes an end cover, a bottom cover and a filter cylinder, and the two ends of the filter cylinder are respectively connected with the end cover and the bottom cover, and the filter cylinder is used for filtering and purifying the air, a cleaning assembly is arranged in the filter cylinder for removing dust adsorbed on the filter cylinder; the centrifugal fan is installed in the third chamber. In the present application, a negative ion generator is arranged in the cabinet, and the negative ion generator generates negative ions to charge the dust in the air, so that the charged dust is adsorbed on the air filter cartridge during the air flow process, the air through the air filter cartridge is cleaned to achieve air purification.

This application claims priority to Chinese Patent Application No. 201811107268.X, filed to the Chinese Patent Office on Sep. 21, 2018, entitled “an air purification device with filter cartridge self-cleaning”, the entire disclosure of which is incorporated herein by reference.

### BACKGROUND

### Technical Field

The present invention relates to the field of air purification technology, and in particular, to an air purification device with filter cartridge self-cleaning.

### Background Art

Whether it is a civilian building where humans live or work, or a modern industrial building, maintaining indoor air cleanliness is essential to ensure human health and work efficiency. The air purification device is a key facility for improving the indoor air quality of buildings. Its filtration effect, operating energy consumption and maintenance cost have attracted wide attention in the industry.

### SUMMARY OF THE INVENTION

Based on the technical problems existing in the background art, the present application proposes an air purification device with filter cartridge self-cleaning.

The present application provides an air purification device with filter cartridge self-cleaning, which includes: cabinet, air filter cartridge and centrifugal fan, wherein,

a first mounting plate and a second mounting plate are arranged in the interior of the cabinet from top to bottom, the first mounting plate and the second mounting plate divide the interior of the cabinet into a first chamber, a second chamber, and a third chamber, the first mounting plate is provided with a first opening connecting the first chamber and the second chamber, and the second mounting plate is provided with a second opening connecting the second chamber and the third chamber, and the cabinet is provided with an air inlet communicating with the first chamber, and with a plurality of air outlets communicating with the third chamber;

the air filter cartridge is arranged in the second chamber, the air filter cartridge includes an end cover, a bottom cover and a filter cylinder, the end cover is installed in the second opening and provided with an air inlet, and the two ends of the filter cylinder are respectively connected with the end cover and the bottom cover, and the filter cylinder is used for filtering and purifying the air, a cleaning assembly is arranged in the filter cylinder for removing dust adsorbed on the filter cylinder; the centrifugal fan is installed in the third chamber.

Preferably, the cleaning assembly comprises a suction shaft, a driving mechanism and a suction nozzle, and a fixing plate is arranged in the middle of the air inlet, the fixing plate is connected with the end cover through a plurality of connecting plates, the inside of the suction shaft is hollow, and the two ends of the suction shaft are respectively rotatably connected with the fixed plate and the bottom cover, an air inlet is arranged on the fixed plate communicating with the interior of the suction shaft, and the driving mechanism is connected with the suction shaft for driving the suction shaft to rotate; the suction nozzle is fixed on the suction shaft and rotates with the rotation of the suction shaft, and the suction end of the suction nozzle faces the hollow inner of the suction shaft and the suction nozzle communicates with the inside of the suction shaft.

Preferably, a plurality of bristles are distributed at the suction end of the suction nozzle.

Preferably, the height of the suction nozzle is adapted to the height of the filter cylinder.

Preferably, the bottom cover is mounted on the third mounting plate by a bracket.

Preferably, the filter cylinder comprises a hollow inner cylinder and a hollow outer cylinder, wherein the hollow inner cylinder is disposed inside the hollow outer cylinder, and a filter layer is filled between the hollow inner cylinder and the hollow outer cylinder, and a plurality of first through holes are distributed on the hollow inner cylinder, a plurality of second through holes are distributed on the hollow outer cylinder.

Preferably, an intake damper is arranged at the air inlet.

Preferably, a negative ion generator is provided in the first chamber.

The invention discloses an air purification device with filter cartridge self-cleaning, a negative ion generator is arranged in the cabinet, and the negative ion generator generates negative ions to charge the dust in the air, so that the charged dust is adsorbed on the air filter cartridge during the air flow process, the air through the air filter cartridge is cleaned to achieve air purification. The air filter cartridge of the present application needs to be cleaned after being used for a period of time. The air inlet is connected with a vacuum cleaner, the driving mechanism drives the suction shaft to rotate to take the suction nozzle to rotate. The dust adsorbed on the filter cylinder are swept off by the bristles on the suction nozzle and sucked from the suction nozzle, the internal cavity of the suction shaft, and the air inlet into the vacuum cleaner. The dust adsorbed on the air filter cartridge can be effectively removed. The present application can realize automatic cleaning and has a long service life.

### BRIEF DESCRIPTION OF DRAWING

FIG. 1 is a schematic view of an air purification device with filter cartridge self-cleaning according to the present application;

FIG. 2 is a schematic view of the air filter cartridge of the air purification device with filter cartridge self-cleaning according to the present application;

FIG. 3 is a sectional view of the air filter cartridge of the air purification device with filter cartridge self-cleaning according to the present application.

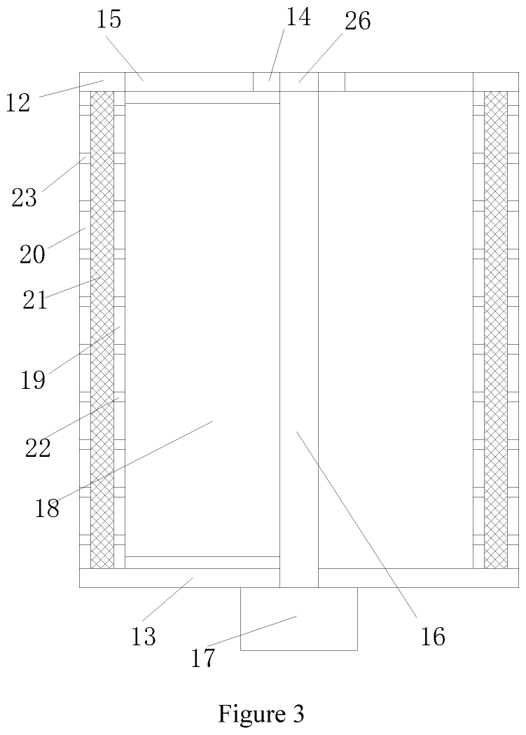

### DETAILED DESCRIPTION OF THE EMBODIMENTS

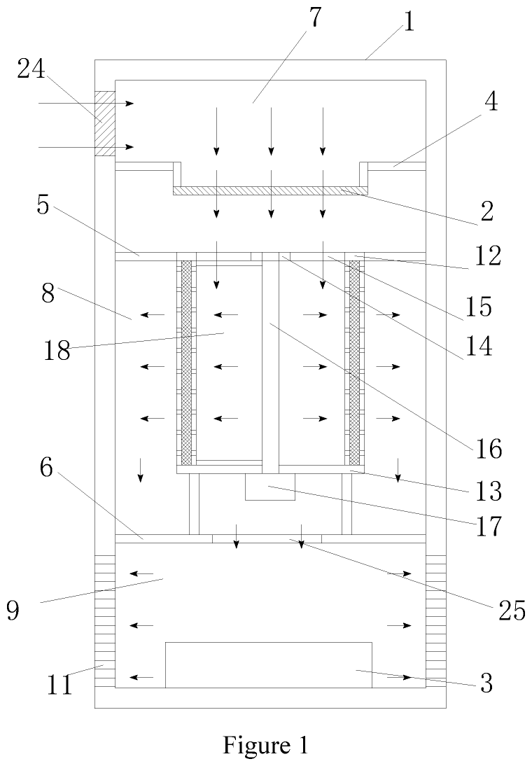

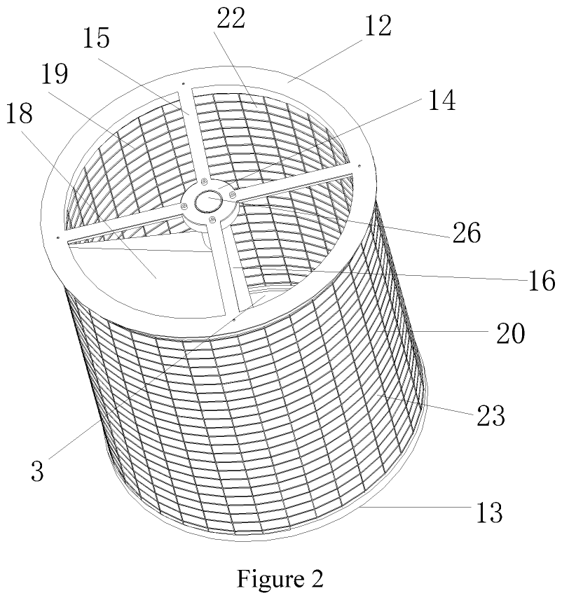

Referring to FIG. 1 and FIG. 2, the present application provides an air purification device with filter cartridge self-cleaning, which includes cabinet 1, air filter cartridge and centrifugal fan 3, wherein,

A first mounting plate 5 and a second mounting plate 6 are arranged in the interior of the cabinet 1 from top to bottom, the first mounting plate 5 and the second mounting plate 6 divide the interior of the cabinet 1 into a first chamber 7, a second chamber 8, and a third chamber 9, the first mounting plate 5 is provided with a first opening connecting the first chamber 7 and the second chamber 8, and the second mounting plate 6 is provided with a second opening 25 connecting the second chamber 8 and the third chamber 9, and the cabinet 1 is provided with an air inlet communicating with the first chamber 7, and with a plurality of air outlets 11 communicating with the third chamber 9.

A negative ion generator 2 is provided in the first chamber 7.

The air filter cartridge is arranged in the second chamber 8, the air filter cartridge includes an end cover 12, a bottom cover 13 and a filter cylinder, the end cover 12 is installed in the second opening, and the two ends of the filter cylinder are respectively connected with the end cover 12 and the bottom cover 13, and the filter cylinder is used for filtering and purifying the air. The filter cylinder comprises a hollow inner cylinder 19 and a hollow outer cylinder 20, wherein the hollow inner cylinder 19 is disposed inside the hollow outer cylinder 20, and a filter layer 21 is filled between the hollow inner cylinder 19 and the hollow outer cylinder 20, and a plurality of first through holes 22 are distributed on the hollow inner cylinder 19, a plurality of second through holes 23 are distributed on the hollow outer cylinder 20. The end cover 12 is provided with an air inlet communicating with the interior of the hollow inner cylinder 19. A cleaning assembly is arranged in the filter cylinder for removing dust adsorbed on the filter cylinder; the cleaning assembly comprises a suction shaft 16, a driving mechanism 17 and a suction nozzle 18, and a fixing plate 14 is arranged in the middle of the air inlet, the fixing plate 14 is connected with the end cover 12 through a plurality of connecting plates 15, the inside of the suction shaft 16 is hollow, and the two ends of the suction shaft 16 are respectively rotatably connected with the fixed plate 14 and the bottom cover 13, an air inlet 26 is arranged on the fixed plate 14 communicating with the interior of the suction shaft 16, and the driving mechanism 17 is connected with the suction shaft 16 for driving the suction shaft 16 to rotate; the suction nozzle 18 is fixed on the suction shaft 16 and rotates with the rotation of the suction shaft 16, the height of the suction nozzle 18 is adapted to the height of the filter cylinder, and the suction end of the suction nozzle 18 faces the hollow inner cylinder 19 and the suction nozzle 18 communicates with the inside of the suction shaft 16. A plurality of bristles are distributed at the suction end of the suction nozzle 18.

The centrifugal fan 3 is installed in the third chamber 9.

The invention discloses an air purification device with filter cartridge self-cleaning, a negative ion generator 2 is arranged in the cabinet 1, and the negative ion generator 2 generates negative ions to charge the dust in the air, so that the charged dust is adsorbed on the air filter cartridge during the air flow process, the air through the air filter cartridge is cleaned to achieve air purification. The air filter cartridge of the present application needs to be cleaned after being used for a period of time. The air inlet 26 is connected with a vacuum cleaner, the driving mechanism 17 drives the suction shaft 16 to rotate to take the suction nozzle 18 to rotate. The dust adsorbed on the filter cylinder are swept off by the bristles on the suction nozzle 18 and sucked from the suction nozzle 18, the internal cavity of the suction shaft 16, and the air inlet 26 into the vacuum cleaner. The dust adsorbed on the air filter cartridge can be effectively removed. The present application can realize automatic cleaning and has a long service life.

The above is only the preferred embodiment of the present application, but the scope of protection of the present application is not limited thereto, and any equivalents or modifications of the technical solutions of the present application and the application concept thereof should be included in the scope of the present application within the scope of the technical scope of the present application.

1. An air purification device with filter cartridge self-cleaning, comprising: a cabinet, an air filter cartridge and a centrifugal fan, wherein:
a first mounting plate and a second mounting plate are arranged in the interior of the cabinet from top to bottom, the first mounting plate and the second mounting plate divide the interior of the cabinet into a first chamber, a second chamber, and a third chamber, the first mounting plate is provided with a first opening connecting the first chamber and the second chamber, and the second mounting plate is provided with a second opening connecting the second chamber and the third chamber, and the cabinet is provided with an air inlet communicating with the first chamber, and with a plurality of air outlets communicating with the third chamber;
the air filter cartridge is arranged in the second chamber, the air filter cartridge includes an end cover, a bottom cover and a filter cylinder, the end cover is installed in the second opening and provided with an air inlet, and two ends of the filter cylinder are respectively connected with the end cover and the bottom cover, and the filter cylinder is used for filtering and purifying the air, a cleaning assembly is arranged in the filter cylinder for removing dust adsorbed on the filter cylinder; the centrifugal fan is installed in the third chamber.

2. The air purification device with filter cartridge self-cleaning according to claim 1, wherein the cleaning assembly comprises a suction shaft, a driving mechanism and a suction nozzle, a fixing plate is arranged in the middle of the air inlet, the fixing plate is connected with the end cover through a plurality of connecting plates, the inside of the suction shaft is hollow, and the two ends of the suction shaft are respectively rotatably connected with the fixed plate and the bottom cover, an air suction port is arranged on the fixed plate communicating with the interior of the suction shaft, and the driving mechanism is connected with the suction shaft for driving the suction shaft to rotate; the suction nozzle is fixed on the suction shaft and rotates with the rotation of the suction shaft, and the suction end of the suction nozzle faces a hollow inner cylinder and the suction nozzle communicates with the inside of the suction shaft.

3. The air purification device with filter cartridge self-cleaning according to claim 2, wherein a plurality of bristles is distributed at the suction end of the suction nozzle.

4. The air purification device with filter cartridge self-cleaning according to claim 3, wherein the height of the suction nozzle is adapted to the height of the filter cylinder.

5. The air purification device with filter cartridge self-cleaning according to claim 3, wherein the bottom cover is mounted on the third mounting plate by a bracket.

6. The air purification device with filter cartridge self-cleaning according to claim 1, wherein the filter cylinder comprises a hollow inner cylinder and a hollow outer cylinder, wherein the hollow inner cylinder is disposed inside the hollow outer cylinder, and a filter layer is filled between the hollow inner cylinder and the hollow outer cylinder, and a plurality of first through holes is distributed on the hollow inner cylinder, a plurality of second through holes is distributed on the hollow outer cylinder.

7. The air purification device with filter cartridge self-cleaning according to claim 1, wherein an intake damper is arranged at the air inlet.

8. The air purification device with filter cartridge self-cleaning according to claim 1, wherein a negative ion generator is provided in the first chamber.
